(19) United States
(12) Patent Application Publication
(10) Pub. No.: US 2021/0010837 A1
(43) Pub. Date: Jan. 14, 2021

(54) TIP-TO-CENTER POINTER ILLUMINATION

(71) Applicant: Continental Automotive Systems, Inc., Auburn Hills, MI (US)

(72) Inventors: Vyacheslav Birman, Auburn Hills, MI (US); Hao Wang, Auburn Hills, MI (US)

(21) Appl. No.: 16/505,943

(22) Filed: Jul. 9, 2019

(51) Int. Cl. G01D 13/22; F21V 7/05; B60K 35/00

(52) U.S. Cl. CPC G01D 13/22; F21Y 2115/10; B60K 35/00; F21V 7/05

(57) ABSTRACT

Tip-to-center illumination of a gauge pointer is provided by an elongated pointer having a hub the bottom surface of which comprises prism-shaped protuberances the surfaces of which receive light from a light source. The gauge pointer, hub and protuberances are a unitary structure made of light-conductive material.

### BACKGROUND

Instrument gauges on motor vehicle instrument panels are illuminated so they can be seen at night. Many gauges use a pointer, which rotates around an axis to indicate a condition to the motor vehicle operator. Providing better, brighter and more uniform illumination to such pointers would be an improvement over the prior art.

### BRIEF DESCRIPTION OF THE FIGURES

FIG. 1A is an exploded view of an apparatus for providing tip-to-center illumination of a pointer for a gauge;

FIG. 1B is a perspective view of a platform that supports the pointer and which is mechanically engaged to the bottom surface of a hub for the pointer shown in FIG. 1;

FIG. 2 is an end view of the elongated pointer showing a portion of the hub and showing prism-shaped protuberances, which form part of the elongated pointer;

FIG. 3 is a bottom perspective view of the elongated pointer shown in FIG. 2;

FIG. 4 is an isolated perspective view of one embodiment of the hub shown in FIG. 2 and FIG. 3;

FIG. 5 is an isolated perspective view of another embodiment of the hub;

FIG. 6 is an isolated view of yet another embodiment of a hub and pointer; and

FIG. 7 is a perspective view of a cap for use with the apparatus shown in FIG. 1.

### DETAILED DESCRIPTION

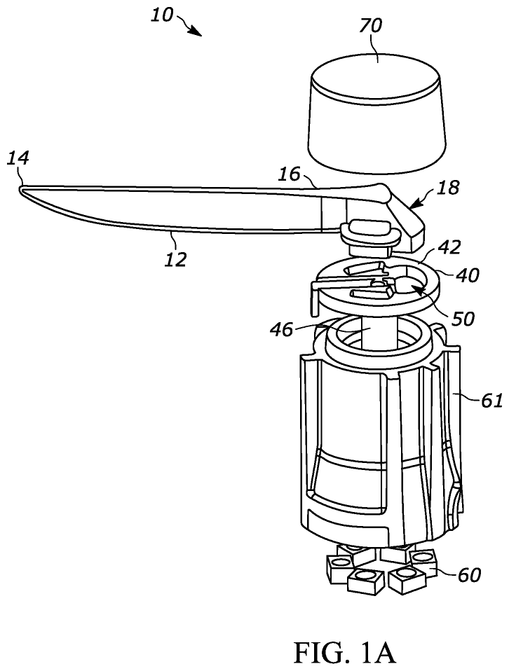

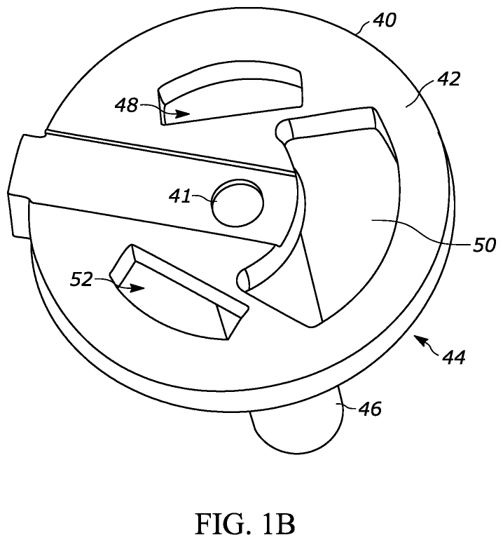

FIG. 1 is an exploded view of an apparatus 10 that provides tip-to-center illumination of a pointer for a gauge. The apparatus comprises of course an elongated pointer 12. The pointer 12 has a first end 14 and a second end 16. The first and second ends are separated from each other by a distance equal to the length of the elongated pointer 12.

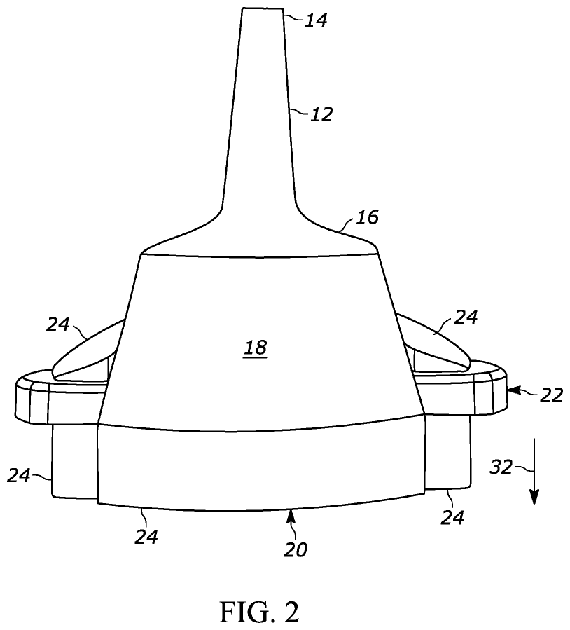

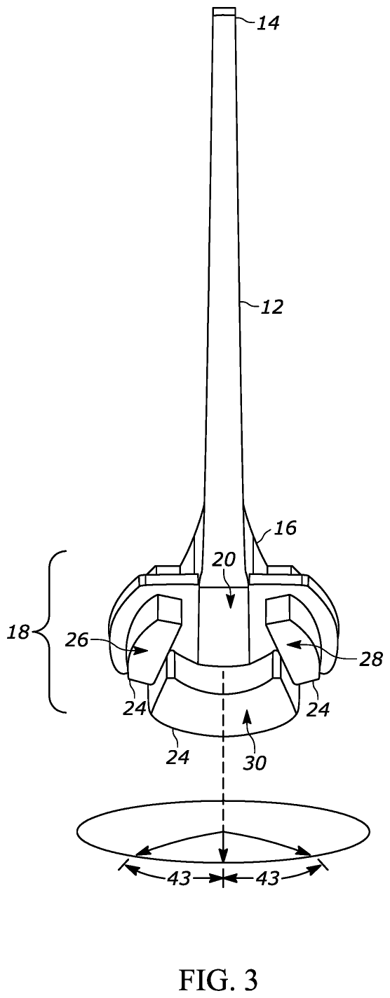

A hub portion 18 is “attached” to the second end 16 of the pointer 12. The hub 18 has a bottom surface 20, best seen in FIG. 2, and a side surface 22. The hub's bottom surface 20, best seen in FIG. 3, is formed to have several prism-shaped protuberances 24, each of which has several external surfaces 26, 28 and 30.

The prism-shaped protuberances are considered herein as extending downwardly 32 and away from the bottom surface 20 of the hub. As best seen in FIG. 1 and FIG. 2, the protuberances 24 also extend upwardly and away from the bottom surface in an opposite direction. Importantly, the elongated pointer 12, hub 18 and the protuberances 24 are a unitary structure made of the same light-conducting material.

As used herein, the term “unitary” means a single unit, which is not divided or divisible. The term “prism-shaped” should be construed to include most three-dimensional rectilinear bodies that include: tetrahedrons, a bisphenoid, a cube, parallelepiped, a prism, a pyramid, a frustrum, obelisk and a wedge. For purposes of clarity, a “prism” is considered to be a solid body bounded by two identical, parallel, similarly-oriented polygonal bases and at least three lateral faces that are parallelograms.

As best seen in FIGS. 1A and 1B, the apparatus 10 also comprises a platform 40, which is sized and shaped to support and mechanically engage the bottom surface 20 of the hub 18. The platform 40 is considered herein as having a substantially planar top surface 42 and a similarly-shaped planar bottom surface 44. An elongated narrow stem 46, which is essentially a shaft, extends away from the bottom surface and is sized and shaped to rotate.

The platform and the hub attached to it rotate around an axis of rotation 41 by a motor or other device, which is not germane to the invention disclosed herein and not shown in the figures. Still referring to FIG. 1B, the platform 40 has several openings 48, 50 and 52 which are located and sized and shaped to be adjacent to a corresponding surface of one of the prism-shaped protuberances 26, 28 and 30 respectively such that light passing through one or more of the openings 48, 50 and 52 will travel toward the hub 18, through the openings and into a surface of one or more of the protuberances. Light that enters the protuberances will travel into the hub, and from there into the elongated pointer 12. The protuberances thus provide a mechanism by which additional light from a light source is captured and directed into the elongated pointer.

As best seen in FIG. 1A, the apparatus for providing tip-to-center illumination also comprises a light source 60 which in FIG. 1A is a series of light emitting diodes located at the bottom of a substantially-cylindrical shaped housing 61. The light source is located away from the bottom surface of the platform. Light emitted from the light source travels upwardly through the cylindrical housing, through the openings and into the protuberances of the hub.

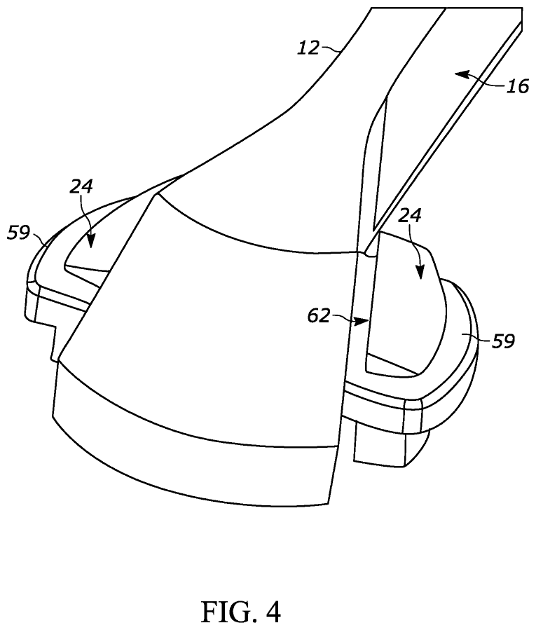

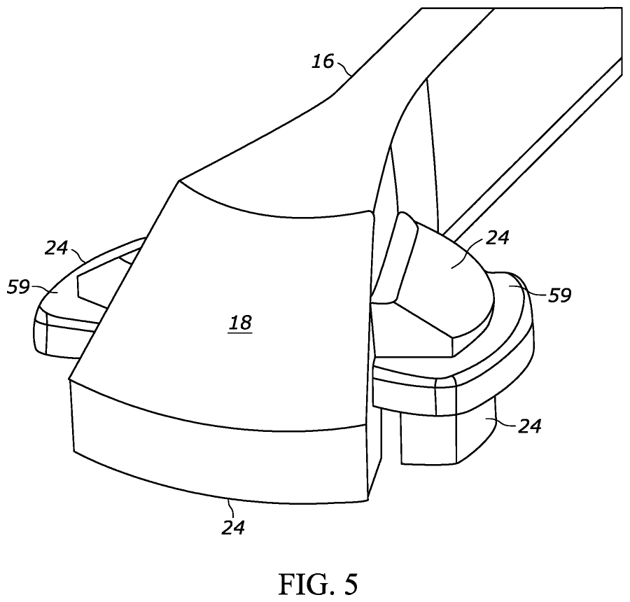

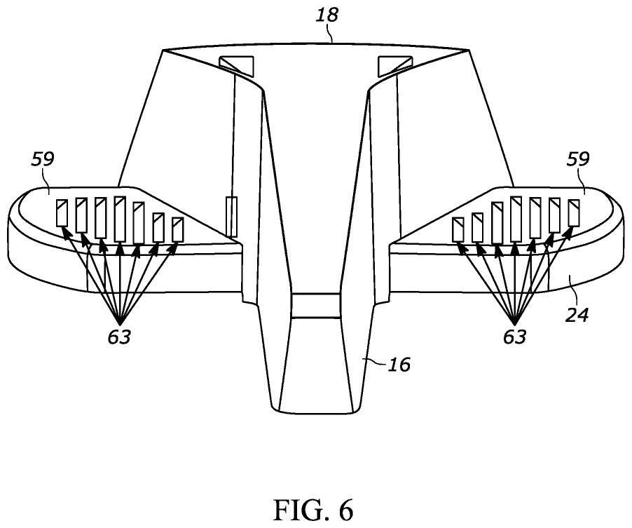

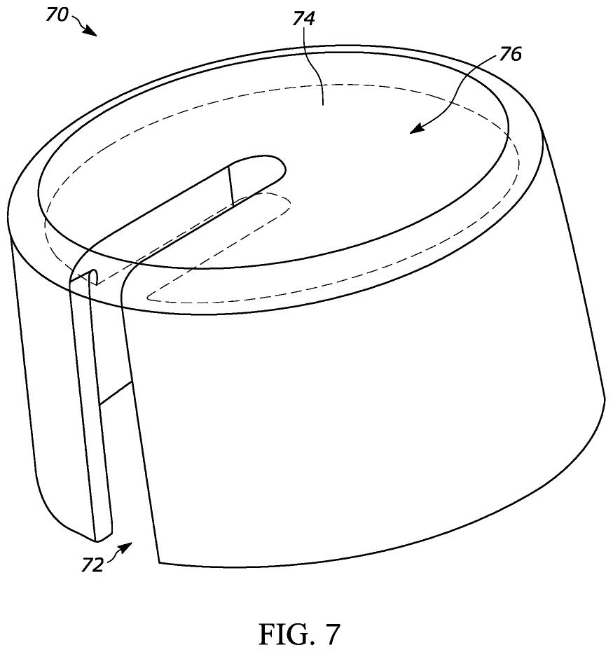

As best seen in FIG. 4, a preferred embodiment of the hub separates the prism-shaped protuberances by a small air gap 62 between the hub and the protuberances. Experimentation revealed that the air gap improved the light transmission over another embodiment of the hub shown in FIG. 5 wherein the protuberances abut the hub, i.e., no air gap is between the hub and protuberances.

In FIG. 5, another version of the hub does not have protuberances above the hub's top surface 59. Grooves 63 are instead formed in the top hub's top surface. The grooves 63 reflect light and increase the illumination of the pointer using light received at the bottom of the hub.

As best seen in FIG. 3, the prism-shaped protuberances are separated from each other around the axis of rotation by an angle 43. In a preferred embodiment the angle of separation between the protuberances was between about 90 degrees and 180 degrees.

As best seen in FIG. 2, the hub is considered herein as having a shape which is reminiscent of a zone of a sphere. The hub, of course, has an exterior surface through which light is able to enter.

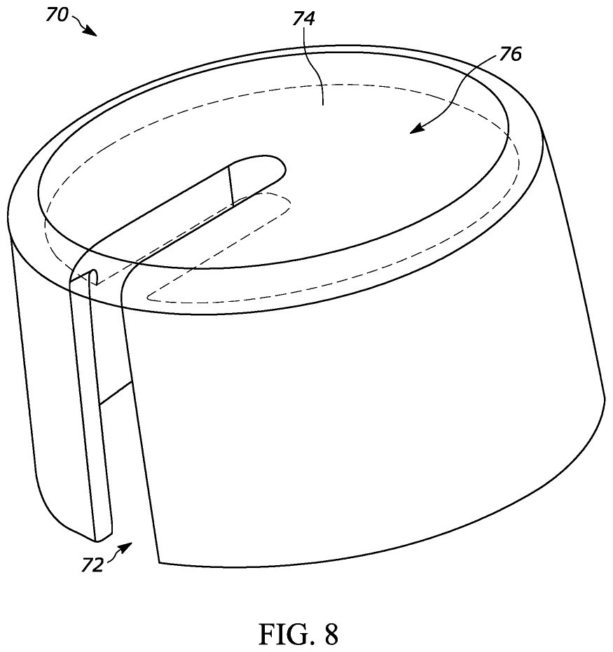

As can be seen in FIG. 1A, the apparatus 10 also includes a cap 70 above the hub portion of the pointer 12. As best seen in FIG. 7, the cap is sized and shaped to fit over the hub and has a slot 72 through which the elongated pointer 12 can extend. In another embodiment, the cap has a top 74, the interior surface of which 76 is coated with a reflective material. Light striking the reflective surface 76 is thus reflected downwardly into the top of the hub from where it can then propagate down the elongated pointer 12.

The foregoing description is for purposes of illustration only. The true scope of the invention is set forth in the following claims.

1. An apparatus (10) providing tip-to-center illumination of a pointer for a gauge, the apparatus comprising:
an elongated pointer (12) having first (14) and second (16) ends;
a hub (18) attached to the second end (16) of the elongated pointer (12), the hub comprising a bottom surface (20) and a side surface (22), the hub's bottom surface comprising a plurality of prism-shaped protuberances, (24) each prism-shaped protuberance having a plurality of external surfaces (26, 28, 30), each prism-shaped protuberance extending downwardly (32) and away from the bottom surface (20) of the hub and extending in an opposite direction upwardly away from the bottom surface of the hub, the elongated pointer, hub and prism-shaped protuberances being a unitary structure and being made of a light conducting material;
a platform (40) that supports and which is mechanically engaged to the bottom surface (20) of the hub (18), the platform having a substantially planar top surface (42) and a substantially planar bottom surface (44) from which extends an elongated narrow stem (46), the elongated narrow stem (46) being sized and shaped to rotate and comprising a shaft, the platform having a plurality of openings (48, 50, 52), each opening of the plurality of openings in the platform being adjacent to a corresponding surface of one of the prism-shaped protuberances such that light passing through the openings travels toward the hub, passes through the openings and into the surface of a corresponding prism-shaped protuberance, into the hub and into the elongated pointer;
a light source (60) located away from the substantially planar bottom surface of the platform;
wherein the hub has an axis of rotation (41), wherein first and second prism-shaped protuberances are separated from each other around the axis of rotation by an angle (43) between ninety degrees and one-hundred eighty degrees; and
wherein light passing through the first and second prism-shaped protuberances enters the hub through the side of the hub.

2. The apparatus of claim 1, wherein one of the prism-shaped protuberances is separated from the side of the hub by an air gap (62).

3. (canceled)

4. The apparatus of claim 1, wherein the hub comprises a portion which is substantially a zone of a sphere, which has an exterior surface.

5. (canceled)

6. The apparatus of claim 1, further comprising a cap (70), the cap being sized and shaped to fit over the hub and having a slot (72) through which the elongated pointer can extend.

7. The apparatus of claim 1, further comprising a cap, the cap being sized and shaped to fit over the hub and having a slot through which the elongated pointer can extend, the cap having a top (74) with an interior surface (76) which is coated with a reflective material.

8. An apparatus (10) providing tip-to-center illumination of a pointer for a gauge, the apparatus comprising:
an elongated pointer (12) having first (14) and second (16) ends;
a hub (18) attached to the second end (16) of the elongated pointer (12), the hub comprising a bottom surface (20) and a side surface (22), the hub's bottom surface comprising a plurality of prism-shaped protuberances, (24) each prism-shaped protuberance having a plurality of external surfaces (26, 28, 30), each prism-shaped protuberance extending downwardly (32) and away from the bottom surface (20) of the hub and extending in an opposite direction upwardly away from the bottom surface of the hub, the elongated pointer, hub and prism-shaped protuberances being a unitary structure and being made of a light conducting material;
a platform (40) that supports and which is mechanically engaged to the bottom surface (20) of the hub (18), the platform having a substantially planar top surface (42) and a substantially planar bottom surface (44) from which extends an elongated narrow stem (46), the elongated narrow stem (46) being sized and shaped to rotate and comprising a shaft, the platform having a plurality of openings (48, 50, 52), each opening of the plurality of openings in the platform being adjacent to a corresponding surface of one of the prism-shaped protuberances such that light passing through the openings travels toward the hub, passes through the openings and into the surface of a corresponding prism-shaped protuberance, into the hub and into the elongated pointer;
a light source (60) located away from the substantially planar bottom surface of the platform;
wherein one of the prism-shaped protuberances is separated from the side of the hub by an air gap (62); and
wherein the hub comprises a portion of a sphere having an exterior surface through which light from the spatially separated prism passes and travels into the elongated pointer.

9. The apparatus of claim 8, wherein the hub comprises a portion which is substantially a zone of a sphere, which has an exterior surface.

10. The apparatus of claim 8, further comprising a cap (70), the cap being sized and shaped to fit over the hub and having a slot (72) through which the elongated pointer can extend.

11. The apparatus of claim 8, further comprising a cap, the cap being sized and shaped to fit over the hub and having a slot through which the elongated pointer can extend, the cap having a top (74) with an interior surface (76) which is coated with a reflective material.
